(19) United States
(12) Patent Application Publication
(10) Pub. No.: US 2026/0237557 A1
(43) Pub. Date: Aug. 13, 2026

(54) POWER STORAGE UNIT

(71) Applicant: Panasonic Intellectual Property Management Co., Ltd., Osaka (JP)

(72) Inventors: HIRONORI ICHINOHASHI, Shiga (JP); YUICHI TASHIRO, Kyoto (JP); KIYOSHI WAKINAKA, Osaka (JP)

(21) Appl. No.: 19/158,067

(22) PCT Filed: Feb. 27, 2024
(86) PCT No.: PCT/JP2024/007118

§ 371 Date: Aug. 20, 2025

(30) Foreign Application Priority Data
Mar. 7, 2023 (JP) 2023-034792

(51) Int. Cl. H01G 2/06

(52) U.S. Cl. CPC H01G 2/065

(57) ABSTRACT

A power storage unit includes a circuit board, a first cell holder, a second cell holder, a first capacitor cell, a second capacitor cell, and a lead holder. The first capacitor cell includes a first cell body including a first end face, and a first lead that is drawn from the first end face and inserted through the circuit board. The second capacitor cell includes a second cell body including a second end face, and a second lead that is drawn from the second end face and inserted through the circuit board. The lead holder includes a first holder that is in contact with the first lead, and a second holder that is in contact with the second lead.

### TECHNICAL FIELD

The present disclosure relates to power storage units, and in particular, a power storage unit including a circuit board and a plurality of capacitor cells.

### BACKGROUND ART

Patent Literature (PTL) 1 discloses a power storage unit that can be used as an auxiliary power supply device of an automobile, etc. For assembling this power storage unit, a circuit board is covered by a holder, a plurality of busbars and a plurality of capacitors are respectively placed in this holder, a lead terminal of each of the capacitors is connected to a corresponding one of the busbars, and then a cover is attached over the holder.

### CITATION LIST

### Patent Literature

Patent Literature 1: Japanese Unexamined Patent Application Publication No. 2017-208481

### SUMMARY OF INVENTION

A power storage unit according to one aspect of the present disclosure includes: a circuit board; a first cell holder and a second cell holder that are attached to the circuit board; a first capacitor cell held by the first cell holder; a second capacitor cell held by the second cell holder; and a lead holder that is attached to the circuit board and located between the first cell holder and the second cell holder. The first capacitor cell includes a first cell body including a first end face, and a first lead that is drawn from the first end face and inserted through the circuit board. The second capacitor cell includes a second cell body including a second end face and a second lead that is drawn from the second end face and inserted through the circuit board. The lead holder includes a first holder facing the first end face of the first cell body and a second holder facing the second end face of the second cell body. The first holder is configured to be in contact with the first lead. The second holder is configured to be in contact with the second lead.

The present disclosure yields an advantageous effect of allowing downsizing of a power storage unit.

### BRIEF DESCRIPTION OF DRAWINGS

FIG. 1 is a front view of a power storage unit according to an embodiment.

FIG. 2 is a cross sectional view taken along line A-A indicated in FIG. 1.

FIG. 3 is a cross sectional view taken along line B-B indicated in FIG. 1.

FIG. 4 is a cross sectional view taken along line C-C indicated in FIG. 1.

FIG. 5 is a perspective view of the power storage unit according to the embodiment.

FIG. 6 is an exploded perspective view of the power storage unit according to the embodiment.

FIG. 7 is a plan view of a first cell holder and a second cell holder included in the power storage unit according to the embodiment.

FIG. 8 is a side view of the first cell holder and the second cell holder included in the power storage unit according to the embodiment.

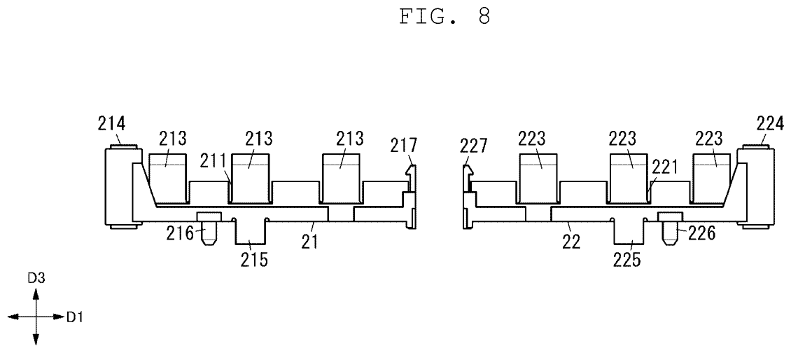

FIG. 9 is a perspective view of a lead holder included in the power storage unit according to the embodiment.

FIG. 10 is a plan view of the lead holder according to the embodiment.

FIG. 11 is a side view of the lead holder according to the embodiment.

FIG. 12 is another side view of the lead holder according to the embodiment.

FIG. 13 is an exploded perspective view of a power storage unit according to a variation.

### DESCRIPTION OF EMBODIMENTS

With the conventional technique described above, it is necessary to place a plurality of busbars in a holder, and further to provide a cover over the busbars, making it difficult to downsize the unit as a whole.

The present disclosure provides a power storage unit that can be downsized.

Hereinafter, a power storage unit according to the present disclosure will be described with reference to the accompanying Drawings. The diagrams referred to in the following embodiment are each a schematic diagram. Accordingly, the ratio of size and thickness of each of the structural components illustrated in the diagram does not necessarily reflect the actual dimensional ratio.

### 1. Embodiment

### (1) Overall Configuration of Power Storage Unit

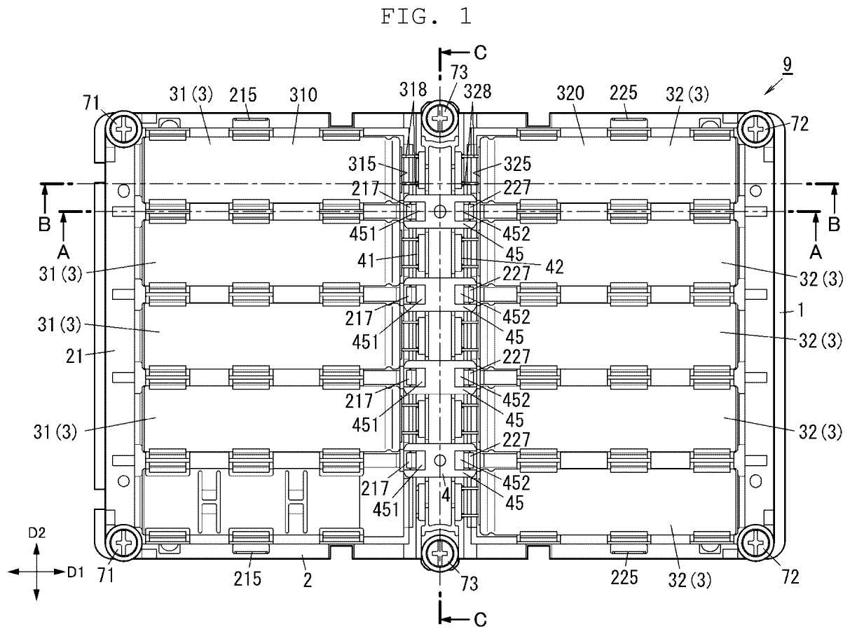

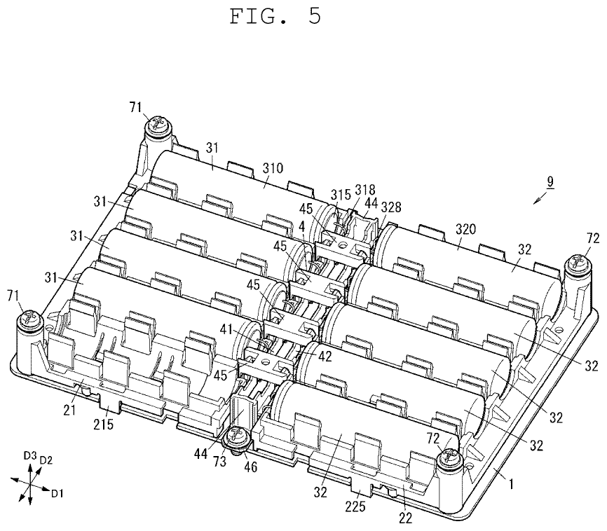

As illustrated in FIG. 1 to FIG. 7, power storage unit 9 according to the embodiment includes circuit board 1, cell holder 2, a plurality of capacitor cells 3, and lead holder 4.

Cell holder 2 includes first cell holder 21 and second cell holder 22 which are separately configured bodies. First cell holder 21 and second cell holder 22 are attached to circuit board 1 to be aligned in first direction D1.

The plurality of capacitor cells 3 include a plurality of first capacitor cells 31 held by first cell holder 21 and a plurality of second capacitor cells 32 held by second cell holder 22. The plurality of first capacitor cells 31 are held by first cell holder 21 to be aligned in second direction D2 perpendicular to first direction D1. The plurality of second capacitor cells 32 are held by second cell holder 22 to be aligned in second direction D2.

Lead holder 4 is attached to circuit board 1 to be located between first cell holder 21 and second cell holder 22 in first direction D1. First cell holder 21, second cell holder 22, and lead holder 4 are synthetic resin holders.

### (2) Circuit Board

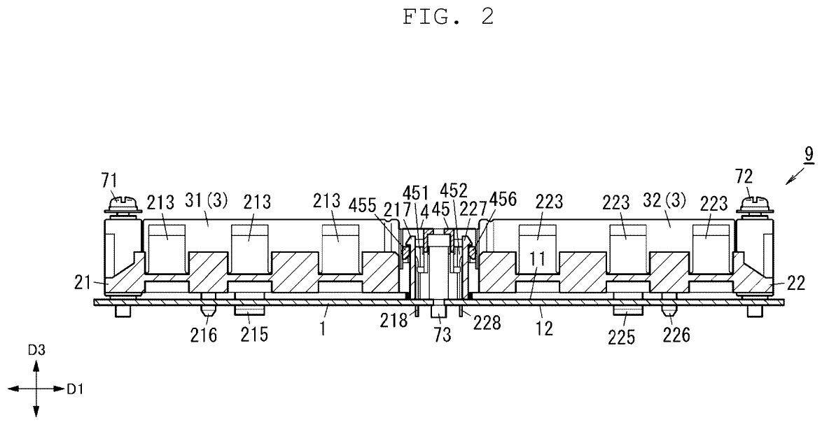

As illustrated in FIG. 2 to FIG. 4, circuit board 1 includes first face 11 and second face 12 facing away from each other in third direction D3. Third direction D3 is perpendicular to first direction D1 and second direction D2.

In power storage unit 9 according to the embodiment, each of first direction D1, second direction D2, and third direction D3 is perpendicular to the remaining two directions.

Second face 12 of circuit board 1 is a face on which non-illustrated circuit components are mounted. The circuit components are mounted on second face 12 of circuit board 1 to constitute a charge and discharge circuit that controls charge and discharge of the plurality of capacitor cells 3 held by cell holder 2. One or more of the circuit components constituting the charge and discharge circuit may be mounted on a portion of first face 11 of circuit board 1 where placement of cell holder 2 is not hindered.

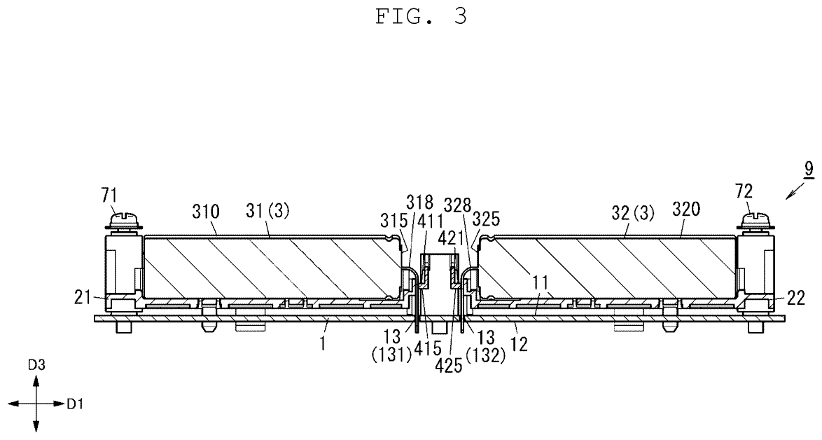

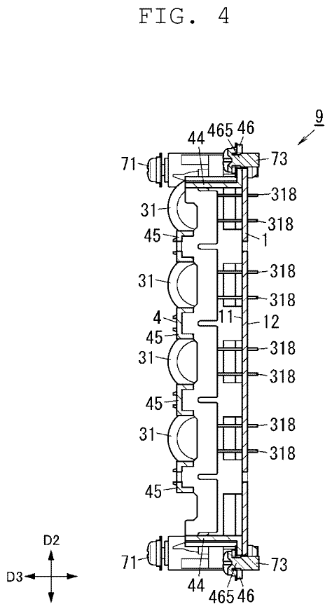

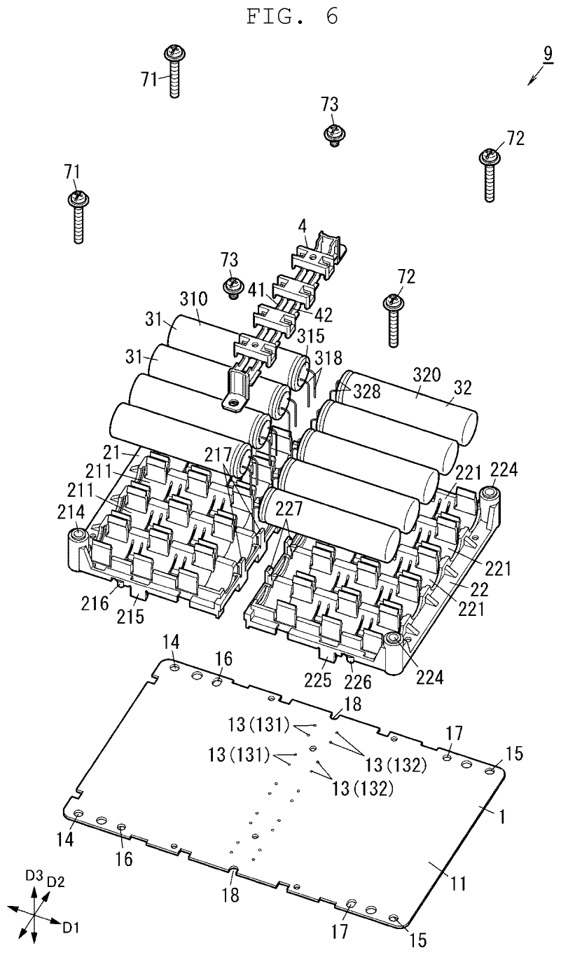

As illustrated in FIG. 3, FIG. 4, and FIG. 6, a plurality of holes 13 for insertion of leads are provided in circuit board 1. The plurality of holes 13 are provided in an intermediate portion of circuit board 1 in first direction D1. The plurality of holes 13 are aligned in two rows. The plurality of holes 13 each penetrate through circuit board 1 in third direction D3. Each of the plurality of holes 13 is open on first face 11 of circuit board 1 and is open on second face 12 of circuit board 1.

In power storage unit 9 according to the embodiment, a pair of holes 13 are provided for one capacitor cell 3. In first direction D1, the pair of holes 13 are located adjacent to an end face of corresponding capacitor cell 3.

The plurality of holes 13 include a plurality of first holes 131 aligned in a row to correspond to the plurality of first capacitor cells 31 and a plurality of second holes 132 aligned in a row to correspond to the plurality of second capacitor cells 32. The plurality of first holes 131 are, for example, five pairs of first holes 131 and the plurality of second holes 132 are, for example, five pairs of second holes 132.

In the state in which first cell holder 21 and lead holder 4 are attached to circuit board 1, the row of first holes 131 of circuit board 1 is located between first cell holder 21 and lead holder 4. In the state in which second cell holder 22 and lead holder 4 are attached to circuit board 1, the row of second holes 132 of circuit board 1 is located between second cell holder 22 and lead holder 4. The row of first hole 131 and the row of second hole 132 are parallel to each other.

In power storage unit 9 according to the embodiment, a pair of first holes 131 are provided to correspond to one first capacitor cell 31, and a pair of second holes 132 are provided to correspond to one second capacitor cell 32.

In addition, circuit board 1 is provided with a plurality of fixture holes 14 and 15 into which a plurality of fixtures 71 and 72 for fixing cell holder 2 are inserted, a plurality of insertion holes 16 and 17 into which a portion of cell holder 2 is inserted, and a plurality of fixture holes 18 into which a plurality of fixtures 73 for fixing lead holder 4 are inserted. The plurality of fixtures 71 and 72 and the plurality of fixtures 73 are each a fixation screw.

The plurality of fixture holes 14 and 15 include a plurality of fixture holes 14 into which the plurality of fixtures 71 for fixing first cell holder 21 are inserted, and a plurality of fixture holes 15 into which the plurality of fixtures 72 for fixing second cell holder 22 are inserted. Each of the plurality of fixture holes 14 and 15 penetrates through circuit board 1 in third direction D3. Each of the plurality of fixture holes 14 and 15 is open on first face 11 of circuit board 1 and is open on second face 12 of circuit board 1. The plurality of fixture holes 14 and 15 are, for example, four fixture holes 14 and 15, and located one by one at four corners of circuit board 1 having a quadrilateral flat-plate shape.

The plurality of insertion holes 16 and 17 include a plurality of insertion holes 16 into which a portion of first cell holder 21 is inserted, and a plurality of insertion holes 17 into which a portion of second cell holder 22 is inserted. Each of the plurality of insertion holes 16 and 17 penetrates through circuit board 1 in third direction D3. Each of the plurality of insertion holes 16 and 17 is open on first face 11 of circuit board 1 and is open on second face 12 of circuit board 1. The plurality of insertion holes 16 are, for example, two insertion holes 16. The plurality of insertion holes 17 are, for example, two insertion holes 17.

The plurality of fixture holes 18 are two fixture holes 18 provided at both end portions of circuit board 1 in first direction D1. Each of the plurality of fixture holes 18 penetrates through circuit board 1 in third direction D3. Each of the plurality of fixture holes 18 is open on first face 11 of circuit board 1 and is open on second face 12 of circuit board 1.

### (3) First Cell Holder

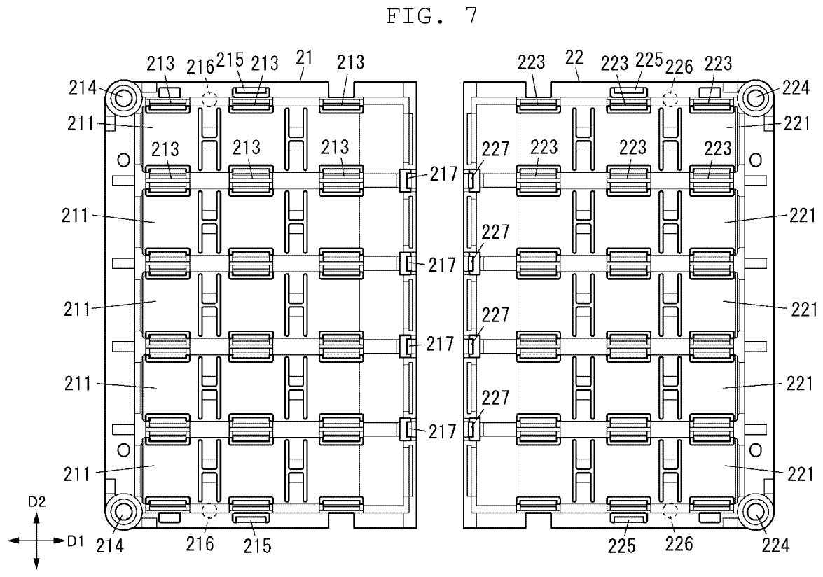

As illustrated in FIG. 7, first cell holder 21 includes a plurality of first holders 211 aligned in a row in second direction D2. The plurality of first holders 211 are, for example, five first holders 211. The five first holders 211 are provided to be capable of holding five first capacitor cells 31 in a one-to-one relationship.

The plurality of first holders 211 each have a recessed semicircular shape in cross-section (see FIG. 6). The plurality of first holders 211 are each configured to allow a corresponding one of first capacitor cells 31 to fit in.

Each of the plurality of first holders 211 is provided with a plurality of elastic pieces 213 that elastically hold first capacitor cell 31 The plurality of elastic pieces 213 are, for example, six elastic pieces 213. The six elastic pieces 213 include three elastic pieces 213 that protrude from an edge portion of first holder 211 on the first side in second direction D2, and other three elastic pieces 213 that protrude from an edge portion of first holder 211 on the second side in second direction D2. These six elastic pieces 213 elastically sandwich corresponding first capacitor cell 31 from both sides in second direction D2, thereby elastically holding first capacitor cell 31.

The above-described configuration allows first cell holder 21 to hold five first capacitor cells 31 to be aligned in second direction D2.

In addition, first cell holder 21 includes a plurality of fixture holes 214, a plurality of hooks 215, a plurality of protrusions 216, and a plurality of first locking portions 217.

The plurality of fixture holes 214 are, for example, two fixture holes 214. Fixture 71 is inserted into each of the two fixture holes 214. In the state in which first cell holder 21 is attached to circuit board 1 (hereinafter referred to as “attached state of first cell holder 21”), each of the plurality of fixture holes 214 of first cell holder 21 is communicated with a corresponding one of the plurality of fixture holes 14 of circuit board 1.

The plurality of hooks 215 are, for example, two hooks 215. The plurality of hooks 215 are each locked to circuit board 1. In the attached state of first cell holder 21, the two hooks 215 of first cell holder 21 are elastically hooked onto the both edge portions of circuit board 1 in second direction D2.

The plurality of protrusions 216 are, for example, two protrusions 216. In the attached state of first cell holder 21, each of the plurality of protrusions 216 of first cell holder 21 protrudes toward circuit board 1, and is inserted into a corresponding one of the plurality of insertion holes 16 of circuit board 1.

The plurality of first locking portions 217 are each locked to lead holder 4. The plurality of first locking portions 217 are, for example, four first locking portions 217. In the attached state of first cell holder 21, each of the plurality of first locking portions 217 protrudes in a direction away from circuit board 1, from the edge portion of first cell holder 21 that faces lead holder 4,. The four first locking portions 217 are aligned in a row in second direction D2. In second direction D2, each of the plurality of first locking portions 217 is located between an adjacent pair of first holders 211.

### (4) Second Cell Holder

Second cell holder 22 has a similar configuration to the configuration of first cell holder 21.

Second cell holder 22 includes a plurality of second holders 221 aligned in a row in second direction D2. The plurality of second holders 221 are, for example, five second holders 221. The five second holders 221 are provided to be capable of holding five second capacitor cells 32 in a one-to-one relationship.

The plurality of second holders 221 each have a recessed semicircular shape in cross-section. The plurality of second holders 221 are each configured to allow a corresponding one of second capacitor cells 32 to fit in.

Each of the plurality of second holders 221 is provided with a plurality of elastic pieces 223 that elastically hold second capacitor cell 32 The plurality of elastic pieces 223 are, for example, six elastic pieces 223. The six elastic pieces 223 include three elastic pieces 223 that protrude from an edge portion of second holder 221 on the first side in second direction D2, and other three elastic pieces 223 that protrude from an edge portion of second holder 221 on the second side in second direction D2. These six elastic pieces 223 elastically sandwich a corresponding second capacitor cell 32 from both sides in second direction D2, thereby elastically holding second capacitor cell 32.

The above-described configuration allows second cell holder 22 to hold five second capacitor cells 32 to be aligned in second direction D2.

In addition, second cell holder 22 includes a plurality of fixture holes 224, a plurality of hooks 225, a plurality of protrusions 226, and a plurality of second locking portions 227.

The plurality of fixture holes 224 are, for example, two fixture holes 224. Fixture 72 is inserted into each of the two fixture holes 224. In the state in which second cell holder 22 is attached to circuit board 1 (hereinafter referred to as “attached state of second cell holder 22”), each of the plurality of fixture holes 224 of second cell holder 22 is communicated with a corresponding one of the plurality of fixture holes 15 of circuit board 1.

The plurality of hooks 225 are, for example, two hooks 225. The plurality of hooks 225 are each locked to circuit board 1. In the attached state of second cell holder 22, the two hooks 225 of second cell holder 22 are elastically hooked onto the both edge portions of circuit board 1 in second direction D2.

The plurality of protrusions 226 are, for example, two protrusions 226. In the attached state of second cell holder 22, each of the plurality of protrusions 226 of second cell holder 22 protrudes toward circuit board 1, and is inserted into a corresponding one of the plurality of insertion holes 17 of circuit board 1.

The plurality of second locking portions 227 are each locked to lead holder 4. The plurality of second locking portions 227 are, for example, four second locking portions 227. In the attached state of second cell holder 22, each of the plurality of second locking portions 227 protrudes in a direction away from circuit board 1, from the edge portion of second cell holder 22 that faces lead holder 4. The four second locking portions 227 are aligned in a row in second direction D2. In second direction D2, each of the plurality of first locking portions 217 is located between an adjacent pair of first holders 211.

### (5) First Capacitor Cell

As illustrated in FIG. 1, etc., first capacitor cell 31 includes first cell body 310 having a cylindrical shape, and a pair of first leads 318 drawn from first end face 315 of first cell body 310. First end face 315 is one side face of first cell body 310 in the axial direction. The pair of first leads 318 are first lead 318 of the positive electrode and first lead 318 of the negative electrode, both of which are flexible.

In the state in which first capacitor cell 31 is held by first holder 211 of first cell holder 21, the axial direction of first cell body 310 matches first direction D1. First end face 315 of first capacitor cell 31 is located on the side of first capacitor cell 31 close to second cell holder 22, and faces lead holder 4.

The pair of first leads 318 drawn from first end face 315 of first capacitor cell 31 are inserted through a pair of first holes 131 adjacent to first end face 315 in first direction D1 (see FIG. 3), and electrically connected to the charge and discharge circuit provided on first face 11 of circuit board 1.

### (6) Second Capacitor Cell

As illustrated in FIG. 1, etc., second capacitor cell 32 includes second cell body 320 having a cylindrical shape, and a pair of second leads 328 drawn from second end face 325 of second cell body 320. Second end face 325 is one side face of second cell body 320 in the axial direction. The pair of second leads 328 are second lead 328 of the positive electrode and second lead 328 of the negative electrode, both of which are flexible.

In the state in which second capacitor cell 32 is held by second holder 221 of second cell holder 22, the axial direction of second cell body 320 matches first direction D1. Second end face 325 of second capacitor cell 32 is located on the side of second capacitor cell 32 close to first cell holder 21, and faces lead holder 4.

The pair of second leads 328 drawn from second end face 325 of second capacitor cell 32 are inserted through a pair of second holes 132 adjacent to second end face 325 in first direction D1 (see FIG. 3), and electrically connected to the charge and discharge circuit provided on first face 11 of circuit board 1.

### (7) Lead Holder

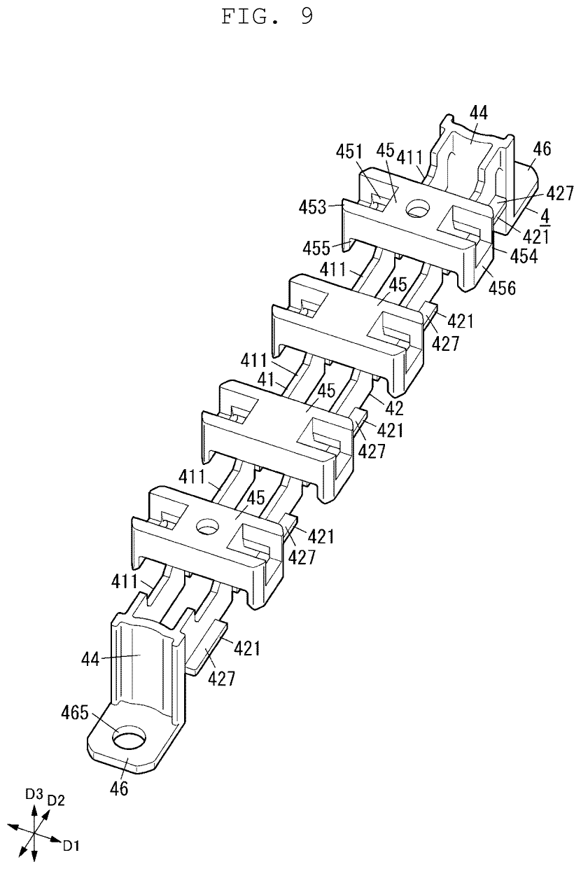

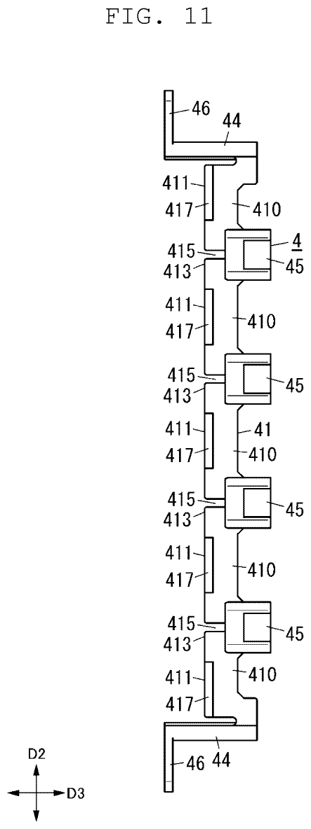

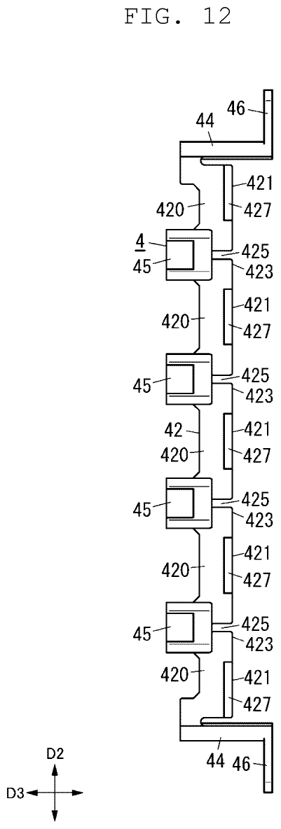

As illustrated in FIG. 9 to FIG. 12, lead holder 4 includes first holder 41, second holder 42, a plurality of joint portions 44, a plurality of intermediate supporters 45, and a plurality of fixing portions 46.

First holder 41 is located adjacent to first cell holder 21 in first direction D1 to face first cell holder 21. Second holder 42 is located adjacent to second cell holder 22 in first direction D1 to face second cell holder 22.

The plurality of joint portions 44 are portions that joint first holder 41 and second holder 42, and are formed integrally with first holder 41 and second holder 42. The plurality of joint portions 44 are, for example, two joint portions 44.

The plurality of intermediate supporters 45 are portions that connect first holder 41 and second holder 42, and are formed integrally with first holder 41 and second holder 42. The plurality of intermediate supporters 45 are, for example, four intermediate supporters 45.

The plurality of fixing portions 46 are portions that are used for fixing lead holder 4 to circuit board 1, and are formed integrally with first holder 41 and second holder 42. The plurality of fixing portions 46 are, for example, two fixing portions 46.

### (7-1) First Holder

First holder 41 includes a plurality of pressing portions 411 and a plurality of intermediate portions 413.

The plurality of pressing portions 411 are five pressing portions 411 that are aligned in a row and spaced apart from each other in second direction D2. The plurality of intermediate portions 413 are four intermediate portions 413 that are aligned in a row and spaced apart from each other in second direction D2. Pressing portion 411 and intermediate portion 413 are alternately located in second direction D2, and connected integrally and linearly with each other.

One corresponding intermediate portion 413 among the four intermediate portions 413 is provided between an adjacent pair of pressing portions 411 among the five pressing portions 411. The one corresponding intermediate portion 413 is intermediate portion 413 connecting the adjacent pair of pressing portions 411.

### (7-1-1) Pressing Portion

Pressing portion 411 faces, in first direction D1, corresponding first holder 211 and first capacitor cell 31 held by the corresponding first holder 211. Pressing portion 411 faces first end face 315 of corresponding first capacitor cell 31 in a one-to-one relationship.

Pressing portion 411 includes first facing surface 410 facing first cell holder 21 and first raised portion 417 raised from a portion of first facing surface 410.

First facing surface 410 is a flat surface provided to face first end face 315 of first capacitor cell 31. First facing surface 410 is a plane perpendicular to first direction D1.

First raised portion 417 has an elongated shape extending in second direction D2. First raised portion 417 is raised from an end portion of first facing surface 410 on the side close to circuit board 1 in third direction D3, toward first cell holder 21 and first capacitor cell 31 held by first cell holder 21.

Pressing portion 411 having the above-described configuration is provided to be in contact with a pair of first leads 318 of corresponding first capacitor cell 31. More specifically, each of pressing portions 411 included by first holder 41 is configured to press a pair of first leads 318 of corresponding first capacitor cell 31 as a result of the pair of first leads 318 being in contact with first raised portion 417.

(7-1-2) Intermediate Portion Intermediate portion 413 is located between an adjacent pair of pressing portions 411 in second direction D2, to connect the adjacent pair of pressing portions 411.

The four intermediate portions 413 included by first holder 41 are each provided with first cutout 415 having a slit-like shape. In other words, first holder 41 includes a plurality of first cutouts 415 located away from each other in second direction D2. The plurality of first cutouts 415 are, for example, four first cutouts 415.

Each of the four first cutouts 415 is cut out linearly from an end portion of corresponding intermediate portion 413 on the side close to circuit board 1 in third direction D3, toward the side away from circuit board 1. The four first cutouts 415 are parallel to each other.

### (7-2) Second Holder

Second holder 42 has a similar configuration to the configuration of first holder 41.

Second holder 42 includes a plurality of pressing portions 421 and a plurality of intermediate portions 423.

The plurality of pressing portions 421 are five pressing portions 421 that are aligned in a row and spaced apart from each other in second direction D2. The plurality of intermediate portions 423 are four intermediate portions 423 that are aligned in a row and spaced apart from each other in second direction D2. Pressing portion 421 and intermediate portion 423 are alternately located in second direction D2, and connected integrally and linearly with each other.

One corresponding intermediate portion 423 among the four intermediate portions 423 is provided between an adjacent pair of pressing portions 421 among the five pressing portions 421. One corresponding intermediate portion 423 is intermediate portion 423 connecting the adjacent pair of pressing portions 421.

### (7-2-1) Pressing Portion

Pressing portion 421 faces, in first direction D1, corresponding second holder 221 and second capacitor cell 32 held by the corresponding second holder 221. Pressing portion 421 faces second end face 325 of corresponding second capacitor cell 32 in a one-to-one relationship.

Pressing portion 421 includes second facing surface 420 facing second cell holder 22 and second raised portion 427 raised from a portion of second facing surface 420.

Second facing surface 420 is a flat surface provided to face second end face 325 of second capacitor cell 32. Second facing surface 420 is perpendicular to first direction D1.

Second raised portion 427 has an elongated shape extending in second direction D2. Second raised portion 427 is raised from an end portion of second facing surface 420 on the side close to circuit board 1 in third direction D3, toward second cell holder 22 and second capacitor cell 32 held by second cell holder 22.

Pressing portion 421 having the above-described configuration is provided to be in contact with a pair of second leads 328 of corresponding second capacitor cell 32. More specifically, each of pressing portions 421 included by second holder 42 is configured to press a pair of second leads 328 of corresponding second capacitor cell 32 as a result of the pair of second leads 328 being in contact with second raised portion 427.

### (7-2-2) Intermediate Portion

Intermediate portion 423 is located between an adjacent pair of pressing portions 421 in second direction D2, to connect the adjacent pair of pressing portions 421.

The four intermediate portions 423 included by second holder 42 are each provided with second cutout 425 having a slit-like shape. In other words, second holder 42 includes a plurality of second cutouts 425 located away from each other in second direction D2. The plurality of second cutouts 425 are, for example, four second cutouts 425.

Each of the four second cutouts 425 is cut out linearly from an end portion of corresponding intermediate portion 423 on the side close to circuit board 1 in third direction D3, toward the side away from circuit board 1. The four second cutouts 425 are parallel to each other.

### (7-3) Joint Portion

Among the two joint portions 44 located away from each other in second direction D2, one joint portion 44 is a portion that joints an end portion of first holder 41 on the first side in second direction D2 and an end portion of second holder 42 on the first side in second direction D2, and is formed integrally with first holder 41 and second holder 42.

Another joint portion 44 is a portion that joints an end portion of first holder 41 on the second side in second direction D2 and an end portion of second holder 42 on the second side in second direction D2, and is formed integrally with first holder 41 and second holder 42.

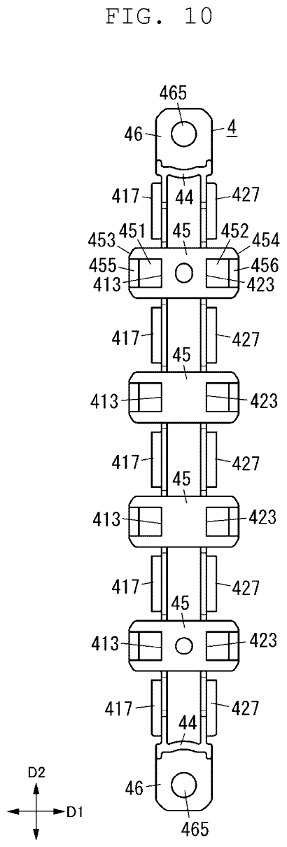

As illustrated in FIG. 10, when viewed in third direction D3, the two joint portions 44 are curved in the direction approaching each other.

### (7-4) Intermediate Supporter

The four intermediate supporters 45 are located between the two joint portions 44 located at the both ends in second direction D2. The four intermediate supporters 45 are located away from each other in second direction D2.

Intermediate supporter 45 is connecting one intermediate portion 413 included in first holder 41 and one intermediate portion 423 included in second holder 42. Intermediate portions 413 and intermediate portions 423 connected by respective intermediate supporters 45 are located to be aligned in first direction D1.

Each of intermediate supporters 45 includes first portion 453 that protrudes from first holder 41 toward the first side in first direction D1 and second portion 454 that protrudes from second holder 42 toward the second side in first direction D1. The first side in first direction D1 is on the side away from second holder 42 relative to first holder 41. The second side in first direction D1 is on the side away from first holder 41 relative to second holder 42.

Each of intermediate supporters 45 further includes first opening portion 451 and second opening portion 452 that are located away from each other in first direction D1.

First opening portion 451 is provided to first portion 453 of intermediate supporter 45. First opening portion 451 is opening toward circuit board 1. In power storage unit 9 according to the embodiment, first opening portion 451 penetrates through first portion 453 in third direction D3. First portion 453 is further provided with locking piece 455 that faces first opening portion 451. Locking piece 455 is a portion onto which first locking portion 217 of first cell holder 21 is hooked.

Second opening portion 452 is provided to second portion 454 of intermediate supporter 45. Second opening portion 452 is opening toward circuit board 1. In power storage unit 9 according to the embodiment, second opening portion 452 penetrates through second portion 454 in third direction D3. Second portion 454 is further provided with locking piece 456 that faces second opening portion 452. Locking piece 456 is a portion onto which second locking portion 227 of second cell holder 22 is hooked.

As illustrated in FIG. 2, etc., first locking portion 217 of first cell holder 21 is inserted into first opening portion 451 of intermediate supporter 45, and a protruding tip portion having a hook-shape of first locking portion 217 is elastically hooked onto locking piece 455 that faces first opening portion 451. In addition, second locking portion 227 of second cell holder 22 is inserted into second opening portion 452 of intermediate supporter 45, and a protruding tip portion having a hook-shape of second locking portion 227 is elastically hooked onto locking piece 456 that faces second opening portion 452.

### (7-5) Fixing Portion

The two fixing portions 46 constitute the end portions of lead holder 4 in second direction D2. Each of fixing portions 46 is provided with fixture hole 465 penetrating therethrough in third direction D3. Fixture hole 465 is a through-hole into which fixture 73 for fixing lead holder 4 is inserted (see FIG. 4).

One fixing portion 46 constituting the end portion of lead holder 4 on the first side in second direction D2 is formed integrally with one joint portion 44. Another fixing portion 46 constituting the end portion of lead holder 4 on the second side in second direction D2 is formed integrally with another joint portion 44.

(8) Assembly Procedure The procedure of assembling power storage unit 9 using circuit board 1, cell holder 2, a plurality of capacitor cells 3, and lead holder 4 (see FIG. 6, etc.) includes a first process of attaching cell holder 2 to circuit board 1, a second process of attaching the plurality of capacitor cells 3 to cell holder 2, and a third process of attaching lead holder 4 to circuit board 1.
(8-1) First Process In the first process, first cell holder 21 and second cell holder 22 that constitute cell holder 2 are attached to first face 11 of circuit board 1. It is optional that a plurality of circuit components are mounted in advance on second face 12 of circuit board 1.

First cell holder 21 is attached to a half portion of first face 11 on the first side in first direction D1. First cell holder 21 is locked to circuit board 1 by elastically hooking two hooks 215 of first cell holder 21 onto the both edge portions of circuit board 1 in second direction D2.

First cell holder 21 is fixed to circuit board 1 using a plurality of fixtures 71 in the state in which first cell holder 21 is locked to circuit board 1 using the two hooks 215. The plurality of fixtures 71 are, for example, two fixtures 71. Each of the two fixtures 71 is inserted into a corresponding one of fixture holes 214 of first cell holder 21 and also into a corresponding one of fixture holes 14 of circuit board 1, and is fixed. As a result, first cell holder 21 is fixed to circuit board 1.

Second cell holder 22 is attached to a half portion of first face 11 on the second side in first direction D1. Second cell holder 22 is locked to circuit board 1 by elastically hooking two hooks 225 of second cell holder 22 onto the both edge portions of circuit board 1 in second direction D2.

Second cell holder 22 is fixed to circuit board 1 using a plurality of fixtures 72 in the state in which second cell holder 22 is locked to circuit board 1 using the two hooks 225. The plurality of fixtures 72 are, for example, two fixtures 72. Each of the two fixtures 72 is inserted into a corresponding one of fixture holes 224 of second cell holder 22 and also into a corresponding one of fixture holes 15 of circuit board 1, and is fixed. As a result, second cell holder 22 is fixed to circuit board 1.

In the state in which first cell holder 21 and second cell holder 22 are attached to circuit board 1, a gap is formed between first cell holder 21 and second cell holder 22. Five pairs of first holes 131 and five pairs of second holes 132 of circuit board 1 are exposed through this gap.

### (8-2) Second Process

In the second process, at least one first capacitor cell 31 is attached to first cell holder 21 that is fixed to circuit board 1, and at least one second capacitor cell 32 is attached to second cell holder 22 that is fixed to circuit board 1. In the illustrated example, four first capacitor cells 31 are attached to first cell holder 21, and five second capacitor cells 32 are attached to second cell holder 22.

First capacitor cells 31 are each fitted to a corresponding one of first holders 211 of first cell holder 21 in an orientation in which first end face 315 faces the second side in first direction D1 (i.e., the side on which second holder 42 is located relative to first holder 41). The pair of first leads 318 drawn from first end face 315 of first capacitor cell 31 are inserted through a corresponding pair of first holes 131.

Second capacitor cells 32 are each fitted to a corresponding one of second holders 221 of second cell holder 22 in an orientation in which second end face 325 faces the first side in first direction D1 (i.e., the side on which first holder 41 is located relative to second holder 42). The pair of second leads 328 drawn from second end face 325 of second capacitor cell 32 are inserted through a corresponding pair of second holes 132.

### (8-3) Third Process

In the third process, lead holder 4 is attached to the intermediate portion of first face 11 of circuit board 1 in the first direction D1.

Four first locking portions 217 of first cell holder 21 are inserted into four first opening portions 451 of first holder 41 in a one-to-one relationship, and four second locking portions 227 of second cell holder 22 are inserted into four second opening portions 452 of second holder 42 in a one-to-one relationship, thereby positioning lead holder 4 on first cell holder 21 and second cell holder 22. In other words, lead holder 4 is positioned on circuit board 1 via first cell holder 21 and second cell holder 22.

First locking portion 217 inserted into a corresponding first opening portion 451 is hooked onto locking piece 455 facing the corresponding first opening portion 451. Second locking portion 227 inserted into a corresponding second opening portion 452 is hooked onto locking piece 456 facing the corresponding second opening portion 452. In this manner, lead holder 4 is locked to first cell holder 21 and second cell holder 22.

Lead holder 4 is fixed to circuit board 1 using a plurality of fixtures 73 in the state in which lead holder 4 is locked to first cell holder 21 and second cell holder 22. The plurality of fixtures 73 are, for example, two fixtures 73. More specifically, each of the two fixtures 73 is inserted into a corresponding one of fixture holes 465 of lead holder 4 and also into a corresponding one of fixture holes 18 of circuit board 1, and is fixed. As a result, lead holder 4 is fixed to circuit board 1.

In the state in which first cell holder 21, second cell holder 22, and lead holder 4 are attached to circuit board 1, a pair of first leads 318 of each of first capacitor cells 31 held by first cell holder 21 are in contact with first raised portion 417 of pressing portion 411 that the pair of first leads 318 are facing, and pressed by first raised portion 417. When viewed in third direction D3, first raised portion 417 is located overlapping a portion of a pair of first holes 131 through which the pair of first leads 318 are inserted.

A pair of second leads 328 of each of second capacitor cells 32 held by second cell holder 22 are in contact with second raised portion 427 of pressing portion 421 that the pair of second leads 328 are facing, and pressed by second raised portion 427. When viewed in third direction D3, second raised portion 427 is located overlapping a portion of a pair of second holes 132 through which the pair of second leads 328 are inserted.

### (9) Advantageous Effects

In power storage unit 9 according to the above-described embodiment, with a single lead holder 4 attached to circuit board 1, it is possible to collectively press a pair of first leads 318 included by each of a plurality of first capacitor cells 31 and a pair of second leads 328 included by each of a plurality of second capacitor cells 32. Accordingly, with power storage unit 9 according to the embodiment, it is possible to reduce a total number of components in power storage unit 9, enabling downsizing of power storage unit 9. In addition, with power storage unit 9 according to the embodiment, it is possible to simplify the assembly work of power storage unit 9.

In addition, in power storage unit 9 according to the embodiment, in lead holder 4, a portion of first holder 41 where first cutout 415 is provided is likely to be more flexible than the other portions, and a portion of second holder 42 where second cutout 425 is provided is likely to be more flexible than the other portions. As a result, it is possible to inhibit applying an uneven load to a particular first capacitor cell 31 among the plurality of first capacitor cells 31, and inhibit applying an uneven load to a particular second capacitor cell 32 among the plurality of second capacitor cells 32.

### 2. Variation

The embodiment described above is merely one of various embodiments of the present disclosure. The embodiment described above can be modified in various ways according to the design, etc., as long as the purposes of the present disclosure can be achieved. In the description of the following variations, the same reference numerals are assigned to the same structural components as in the embodiment described above, and detailed explanations for the same structural components will be omitted.

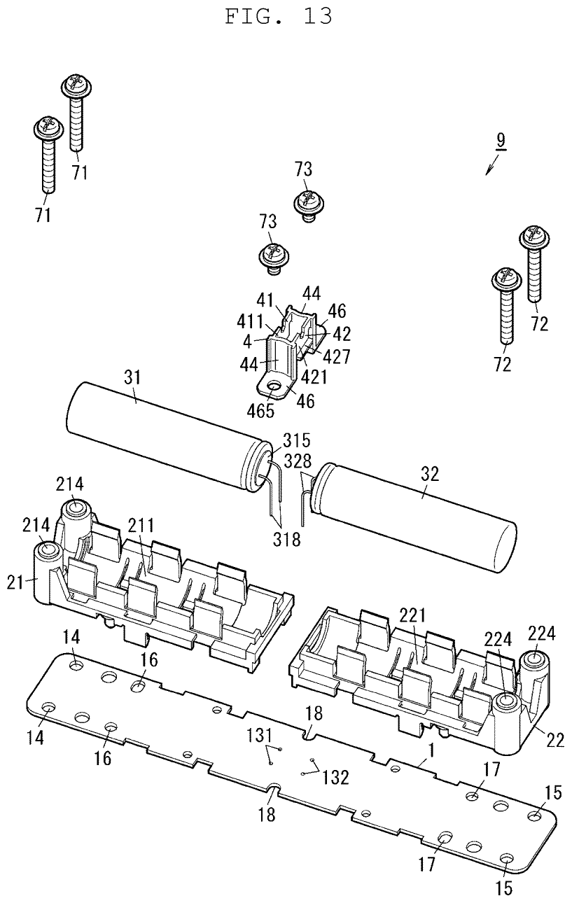

FIG. 13 illustrates a variation of power storage unit 9. In this variation, first cell holder 21 includes only a single first holder 211, and second cell holder 22 includes only a single second holder 221. First holder 41 includes only a single pressing portion 411, and does not include intermediate portion 413. Second holder 42 includes only a single pressing portion 421, and does not include intermediate portion 423.

In other words, in this variation, only a single first capacitor cell 31 is held in first holder 41, instead of a plurality of first capacitor cells 31 being aligned and held. In second holder 42, only a single second capacitor cell 32 is held, instead of a plurality of second capacitor cells 32 being aligned and held. In this variation, a single lead holder 4 that is attached to circuit board 1 is capable of collectively press a pair of first leads 318 of first capacitor cell 31 and a pair of second leads 328 of second capacitor cell 32.

Hereinafter, variations of power storage unit 9 will further be described.

Although a pair of first leads 318 are in contact with first holder 41 and pressed in the above-described embodiment, a single first lead 318 may be in contact with first holder 41 and pressed. Likewise, although a pair of second leads 328 are in contact with second holder 42 and pressed in the above-described embodiment, a single second lead 328 may be in contact with second holder 42 and pressed.

Although lead holder 4 includes four intermediate supporters 45 that are located away from each other in the above-described embodiment, it is sufficient if lead holder 4 includes at least one intermediate supporter 45, and a total number and shape of intermediate supporter 45 are not particularly limited. It is also possible that lead holder 4 does not include intermediate supporter 45 as in the variation illustrated in FIG. 13.

Although first cell holder 21 includes four first locking portions 217 that are located away from each other in the above-described embodiment, it is sufficient if lead holder 4 includes at least one first locking portion 217, and a total number and shape of first locking portion 217 are not particularly limited. It is also possible that first cell holder 21 does not include first locking portion 217 as in the variation illustrated in FIG. 13. Likewise, although second cell holder 22 includes four second locking portions 227 that are located away from each other in the above-described embodiment, it is sufficient if lead holder 4 includes at least one second locking portion 227, and a total number and shape of second locking portion 227 are not particularly limited. It is also possible that second cell holder 22 does not include second locking portion 227 as in the variation illustrated in FIG. 13.

Although intermediate supporters 45 are each include first opening portion 451 and second opening portion 452 in the above-described embodiment, it is also possible that first opening portion 451 and second opening portion 452 are not included. In this case, it is optional that first locking portion 217 and second locking portion 227 are hooked onto other portions of intermediate supporter 45, or onto portions other than intermediate supporter 45.

Although power storage unit 9 according to the above-described embodiment includes both a locking structure to lock lead holder 4 to first cell holder 21 and second cell holder 22 and a fixing structure to fix lead holder 4 to circuit board 1, it is also possible that only the above-described locking structure is included or only the above-described fixing structure is included. In addition, it is also possible that power storage unit 9 includes a fixing structure to fix lead holder 4 to first cell holder 21 and second cell holder 22, or an locking structure to lock lead holder 4 to circuit board 1.

Although first holder 41 includes four first cutouts 415 that are located away from each other in the above-described embodiment, it is sufficient if first holder 41 includes at least one first cutout 415, and a total number and shape of first cutout 415 are not particularly limited. It is also possible that none of intermediate portions 413 of first holder 41 includes first cutout 415, or that at least one of intermediate portions 413 of first holder 41 includes a plurality of first cutouts 415. Likewise, although second holder 42 includes four second cutouts 425 that are located away from each other in the above-described embodiment, it is sufficient if second holder 42 includes at least one second cutout 425, and a total number and shape of second cutout 425 are not particularly limited. It is also possible that none of intermediate portions 423 of second holder 42 includes second cutout 425, or that at least one of intermediate portions 423 of second holder 42 includes a plurality of second cutouts 425.

Although first cell holder 21 includes five first raised portions 417 that are located away from each other in the above-described embodiment, it is sufficient if first cell holder 21 includes at least one first raised portion 417, and a total number and shape of first raised portion 417 are not particularly limited. It is also possible that first cell holder 21 does not include first raised portion 417. Likewise, although second cell holder 22 includes five second raised portions 427 that are located away from each other in the above-described embodiment, it is sufficient if second cell holder 22 includes at least one second raised portion 427, and a total number and shape of second raised portion 427 are not particularly limited. It is also possible that second cell holder 22 does not include second raised portion 427.

The above-described variations can be applied in any combination as appropriate.

### 3. Conclusion

A power storage unit (9) according to a first aspect includes a circuit board (1); a first cell holder (21) and a second cell holder (22) that are attached to the circuit board (1); a first capacitor cell (31) held by the first cell holder (21); a second capacitor cell (32) held by the second cell holder (22); and a lead holder (4) that is attached to the circuit board (1) and located between the first cell holder (21) and the second cell holder (22). The first capacitor cell (31) includes a first cell body (310) including a first end face (315), and a first lead (318) that is drawn from the first end face (315) and inserted through the circuit board (1). The second capacitor cell (32) includes a second cell body (320) including a second end face (325) and a second lead (328) that is drawn from the second end face (325) and inserted through the circuit board (1). The lead holder (4) includes a first holder (41) facing the first end face (315) of the first cell body (310) and a second holder (42) facing the second end face (325) of the second cell body (320). The first holder (41) is configured to be in contact with the first lead (318). The second holder (42) is configured to be in contact with the second lead (328).

According to this aspect, it is possible to collectively press the first lead (318) included by the first capacitor cell (31) and the second lead (328) included by the second capacitor cell (32) by the lead holder (4) that is attached to circuit board (1). As a result, it is possible to downsize the power storage unit (9) as well as to simplify the assembly work of the power storage unit (9).

In the power storage unit (9) of a second aspect according to the first aspect, the first cell holder (21) and the second cell holder (22) that are attached to the circuit board (1) are aligned in a first direction (D1). A plurality of first capacitor cells (31) held by the first cell holder (21) are aligned in a second direction (D2) perpendicular to the first direction (D1), the plurality of first capacitor cells (31) each being the first capacitor cell (31). A plurality of second capacitor cells (32) held by the second cell holder (22) are aligned in the second direction (D2), the plurality of second capacitor cells (32) each being the second capacitor cell (32).

According to this aspect, it is possible to collectively press the first lead (318) included by each of the plurality of first capacitor cells (31) and the second lead (328) included by each of the plurality of second capacitor cells (32) by the lead holder (4) that is attached to circuit board (1). As a result, it is possible to downsize the power storage unit (9) including the plurality of first capacitor cells (31) and the plurality of second capacitor cells (32) as well as to simplify the assembly work of the power storage unit (9).

In the power storage unit (9) of a third aspect according to the second aspect, the plurality of first capacitor cells (31) include a pair of first capacitor cells (31) which are adjacent to each other. The plurality of second capacitor cells (32) include a pair of second capacitor cells (32) which are adjacent to each other. The first holder (41) includes a pressing portion A (411) with which the first lead (318) included by one of the pair of first capacitor cells (31) is in contact, a pressing portion B (411) with which the first lead (318) included by an other of the pair of first capacitor cells (31) is in contact, and an intermediate portion (413) located between the pressing portion A (411) and the pressing portion B (411) of the first holder (41). The second holder (42) includes a pressing portion A (421) with which the second lead (328) included by one of the pair of second capacitor cells (32) is in contact, a pressing portion B (421) with which the second lead (328) included by an other of the pair of second capacitor cells (32) is in contact, and an intermediate portion (423) located between the pressing portion A (421) and the pressing portion B (421) of the second holder (42). The lead holder (4) further includes an intermediate supporter (45) that connects the intermediate portion (413) of the first holder (41) and the intermediate portion (423) of the second holder (42).

According to this aspect, the first holder (41) and the second holder (42) are integrally connected via intermediate supporter (45), and thus it is possible to collectively press the first lead (318) included by each of the plurality of first capacitor cells (31) and the second lead (328) included by each of the plurality of second capacitor cells (32) by simply attaching a single lead holder (4) to the circuit board (1).

In the power storage unit (9) of a fourth aspect according to the first aspect, the lead holder (4) further includes an intermediate supporter (45) that connects the first holder (41) and the second holder (42), the first cell holder (21) includes a first locking portion (217) that is hooked onto the intermediate supporter (45), and the second cell holder (22) includes a second locking portion (227) that is hooked onto the intermediate supporter (45).

According to this aspect, it is possible to hook the lead holder (4) onto the first cell holder (21) and onto the second cell holder (22), using the intermediate supporter (45) that connects the first holder (41) and the second holder (42).

In the power storage unit (9) of a fifth aspect according to the third aspect, the intermediate supporter (45) includes a first opening portion (451) and a second opening portion (452) which are located apart from each other. The first cell holder (21) includes a first locking portion (217) that is inserted into the first opening portion (451) to be hooked onto the intermediate supporter (45). The second cell holder (22) includes a second locking portion (227) that is inserted into the second opening portion (452) to be hooked onto the intermediate supporter (45).

According to this aspect, it is possible to hook the lead holder (4) onto the first cell holder (21) and onto the second cell holder (22), using the first opening portion (451) and the second opening portion (452) of intermediate supporter (45).

In the power storage unit (9) of a sixth aspect according to any one of the second to fifth aspects, the lead holder (4) is fixed to the circuit board (1).

According to this aspect, a portion of the lead holder (4) with which the first lead (318) is in contact and a portion of the lead holder (4) with which the second lead (328) is in contact are each stably fixed to circuit board (1).

In the power storage unit (9) of a seventh aspect according to any one of the second to sixth aspects, the plurality of first capacitor cells (31) include a pair of first capacitor cells (31) which are adjacent to each other. The plurality of second capacitor cells (32) include a pair of second capacitor cells (32) which are adjacent to each other. The first holder (41) includes a pressing portion A (411) with which the first lead (318) included by one of the pair of first capacitor cells (31) is in contact, a pressing portion B (411) with which the first lead (318) included by an other of the pair of first capacitor cells (31) is in contact, and a first cutout (415) located between the pressing portion A (411) and the pressing portion B (411) of the first holder (41). The second holder (42) includes a pressing portion A (421) with which the second lead (328) included by one of the pair of second capacitor cells (32) is in contact, a pressing portion B (421) with which the second lead (328) included by an other of the pair of second capacitor cells (32) is in contact, and a second cutout (425) located between the pressing portion A (421) and the pressing portion B (421) of the first holder (41).

According to this aspect, in the first holder (41), a portion of the first holder (41) where the first cutout (415) is provided is likely to be more flexible than the other portions such as the pressing portion (411). In the second holder (42), a portion of the second holder (42) where the second cutout (425) is provided is likely to be more flexible than the other portions such as the pressing portion (421). As a result, it is possible to inhibit applying an uneven load to a particular first capacitor cell (31) among the plurality of first capacitor cells (31), and inhibit applying an uneven load to a particular second capacitor cell (32) among the plurality of second capacitor cells (32).

In the power storage unit (9) of an eighth aspect according to any one of the first to seventh aspects, the first holder (41) includes (i) a first facing surface (410) that faces the first end face (315) of the first capacitor cell (31) and (ii) a first raised portion (417) raised from a portion of the first facing surface (410), and is configured to be in contact with the first lead (318) at the first raised portion (417). The second holder (42) includes (i) a second facing surface (420) that faces the second end face (325) of the second capacitor cell (32) and (ii) a second raised portion (427) raised from a portion of the second facing surface (420), and is configured to be in contact with the second lead (328) at the second raised portion (427).

According to this aspect, it is possible to stably press the first lead (318) included by the first capacitor cell (31), by the first raised portion (417) that is raised toward the first capacitor cell (31). In addition, it is possible to stably press the second lead (328) included by the second capacitor cell (32), by the second raised portion (427) that is raised toward the second capacitor cell (32).

### REFERENCE SIGNS LIST

1 circuit board
2 cell holder
21 first cell holder
217 first locking portion
22 second cell holder
227 second locking portion
31 first capacitor cell
310 first cell body
315 first end face
318 first lead
32 second capacitor cell
320 second cell body
325 second end face
328 second lead
4 lead holder
41 first holder
410 first facing surface
411 pressing portion (pressing portion A, pressing portion B)
413 intermediate portion
415 first cutout
417 first raised portion
42 second holder
420 second facing surface
421 pressing portion (pressing portion A, pressing portion B)
423 intermediate portion
425 second cutout
427 second raised portion
45 intermediate portion
451 first opening portion
452 second opening portion
9 power storage unit
D1 first direction
D2 second direction

1. A power storage unit comprising:
a circuit board;
a first cell holder and a second cell holder that are attached to the circuit board;
a first capacitor cell held by the first cell holder;
a second capacitor cell held by the second cell holder; and
a lead holder that is attached to the circuit board and located between the first cell holder and the second cell holder, wherein
the first capacitor cell includes a first cell body including a first end face, and a first lead that is drawn from the first end face and inserted through the circuit board,
the second capacitor cell includes a second cell body including a second end face and a second lead that is drawn from the second end face and inserted through the circuit board,
the lead holder includes a first holder facing the first end face of the first cell body and a second holder facing the second end face of the second cell body,
the first holder is configured to be in contact with the first lead, and the second holder is configured to be in contact with the second lead.

2. The power storage unit according to claim 1, wherein
the first cell holder and the second cell holder that are attached to the circuit board are aligned in a first direction;
a plurality of first capacitor cells held by the first cell holder are aligned in a second direction perpendicular to the first direction, the plurality of first capacitor cells each being the first capacitor cell, and
a plurality of second capacitor cells held by the second cell holder are aligned in the second direction, the plurality of second capacitor cells each being the second capacitor cell.

3. The power storage unit according to claim 2, wherein
the plurality of first capacitor cells include a pair of first capacitor cells which are adjacent to each other,
the plurality of second capacitor cells include a pair of second capacitor cells which are adjacent to each other,
the first holder includes a pressing portion A with which the first lead included by one of the pair of first capacitor cells is in contact, a pressing portion B with which the first lead included by an other of the pair of first capacitor cells is in contact, and an intermediate portion located between the pressing portion A and the pressing portion B of the first holder,
the second holder includes a pressing portion A with which the second lead included by one of the pair of second capacitor cells is in contact, a pressing portion B with which the second lead included by an other of the pair of second capacitor cells is in contact, and an intermediate portion located between the pressing portion A and the pressing portion B of the second holder, and
the lead holder further includes an intermediate supporter that connects the intermediate portion of the first holder and the intermediate portion of the second holder.

4. The power storage unit according to claim 1, wherein
the lead holder further includes an intermediate supporter that connects the first holder and the second holder,
the first cell holder includes a first locking portion that is hooked onto the intermediate supporter, and
the second cell holder includes a second locking portion that is hooked onto the intermediate supporter.

5. The power storage unit according to claim 3, wherein
the intermediate supporter includes a first opening portion and a second opening portion which are located apart from each other,
the first cell holder includes a first locking portion that is inserted into the first opening portion to be hooked onto the intermediate supporter, and
the second cell holder includes a second locking portion that is inserted into the second opening portion to be hooked onto the intermediate supporter.

6. The power storage unit according to claim 4, wherein
the lead holder is fixed to the circuit board.

7. The power storage unit according to claim 2, wherein
the plurality of first capacitor cells include a pair of first capacitor cells which are adjacent to each other,
the plurality of second capacitor cells include a pair of second capacitor cells which are adjacent to each other,
the first holder includes a pressing portion A with which the first lead included by one of the pair of first capacitor cells is in contact, a pressing portion B with which the first lead included by an other of the pair of first capacitor cells is in contact, and a first cutout located between the pressing portion A and the pressing portion B of the first holder, and
the second holder includes a pressing portion A with which the second lead included by one of the pair of second capacitor cells is in contact, a pressing portion B with which the second lead included by an other of the pair of second capacitor cells is in contact, and a second cutout located between the pressing portion A and the pressing portion B of the second holder.

8. The power storage unit according to claim 1, wherein
the first holder includes (i) a first facing surface that faces the first end face of the first capacitor cell and (ii) a first raised portion raised from a portion of the first facing surface, and is configured to be in contact with the first lead at the first raised portion, and
the second holder includes (i) a second facing surface that faces the second end face of the second capacitor cell and (ii) a second raised portion raised from a portion of the second facing surface, and is configured to be in contact with the second lead at the second raised portion.
